(19) United States
(12) Patent Application Publication
(10) Pub. No.: US 2003/0075648 A1
(43) Pub. Date: Apr. 24, 2003

(54) Low torque fastener for attaching one object to another

(76) Inventor: Gregg S. Schmidtke, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/076,799

(22) Filed: Oct. 22, 2001

(51) Int. Cl. F16L 3/08

(52) U.S. Cl. 248/74.1

(57) ABSTRACT

In one embodiment, a low torque fastener is disclosed which has capability of securing a first object to a second object. The fastener includes a body which is bendable and which includes a first and a second holes which are located opposite each other, wherein the fastener has a first surface which forms a boundary of the first hole, wherein the first surface is delineated by screw threads, wherein the second hole is larger than the first hole, and wherein bending the body permits the second hole to fully overlay the first hole.

### FIELD OF THE INVENTION

The present invention relates generally to fasteners and, more particularly, to low torque fasteners.

### BACKGROUND OF THE INVENTION

Numerous fasteners in a variety of styles from simple nails to more complex devices are available which provide various means of attaching objects to other objects. Most of these fasteners, however, require either the prior creation of some special geometry in the object to be attached or produce an invasion of the object as a result of their use. An example of the first of these fastener types is a bolt with a nut used to attach two pieces of metal together. A hole drilled or otherwise created in each of the two pieces would be required prior to fastening with the bolt and nut. An example of the second of these fastener types is a wood screw used to attach one piece of wood to another. The screw is first forced through the first piece of wood and then into the second producing a destructive invasion of both objects. Other types of fasteners are also available which neither require the creation of special object geometries, nor do they invade the physical integrity of the objects. A common hose clamp used to clamp an outer flexible pipe around a smaller, more rigid one is an example of such a fastener. In another example of such a fastener, two semicircular shaped bands of metal with bent, mating ends can be used together with bolts through holes in the ends to clamp the outer flexible pipe around the smaller, more rigid one.

Some applications require the alignment of one object with respect to another in the fastening process. For such applications, as for example the attachment of a lens in an optical imaging mechanism, specially-prepared mounting/alignment surfaces are created in the objects which permit a more precise alignment of the lens with respect to the rest of the mechanism. Typically two fasteners are used in such applications to clamp the lens into position. As the fastening points for these fasteners are located some distance from the centerline of the lens, torque applied to either of them can impart a moment to the lens causing it to move from its intended position. A common hose clamp used for this purpose would produce a similar result, as would the two semicircular shaped bands mentioned above. Even if the resulting deviation of the lens from its intended position is small, it can reduce image quality requiring potentially several iterations to readjust.

### SUMMARY OF THE INVENTION

In one embodiment, a fastener is disclosed which has capability of securing a first object to a second object. The fastener includes a body which is bendable and which includes a first and a second holes which are located opposite each other, wherein the fastener has a first surface which forms a boundary of the first hole, wherein the first surface is delineated by screw threads, wherein the second hole is larger than the first hole, and wherein bending the body permits the second hole to fully overlay the first hole.

### BRIEF DESCRIPTION OF THE DRAWINGS

The accompanying drawings provide visual representations which will be used to more fully describe the invention and can be used by those skilled in the art to better understand it and its inherent advantages. In these drawings, like reference numerals identify corresponding elements.

FIG. 1 is a drawing of a fastener as described in various representative embodiments consistent with the teachings of the invention.

FIG. 2 is a drawing of a section of the fastener on line A-A of FIG. 1 as described in various representative embodiments consistent with the teachings of the invention.

FIG. 3 is a drawing of another fastener as described in various representative embodiments consistent with the teachings of the invention.

FIG. 4 is a drawing of the fastener in an application as described in various representative embodiments consistent with the teachings of the invention.

FIG. 5 is a drawing, in an example application, of a section on line B-B of FIG. 4 of the fastener as described in various representative embodiments consistent with the teachings of the invention.

FIG. 6 is a drawing, in another example application, of a section similar to that of line B-B of FIG. 4 of the fastener as described in various representative embodiments consistent with the teachings of the invention.

### DETAILED DESCRIPTION OF THE PREFERRED EMBODIMENTS

As shown in the drawings for purposes of illustration, the present patent document relates to a novel fastener for the attachment of one object to another with minimal torque on the attached object. Applications which need more precise alignment can especially benefit from the low torque characteristics of such fasteners.

In the following detailed description and in the several figures of the drawings, like elements are identified with like reference numerals.

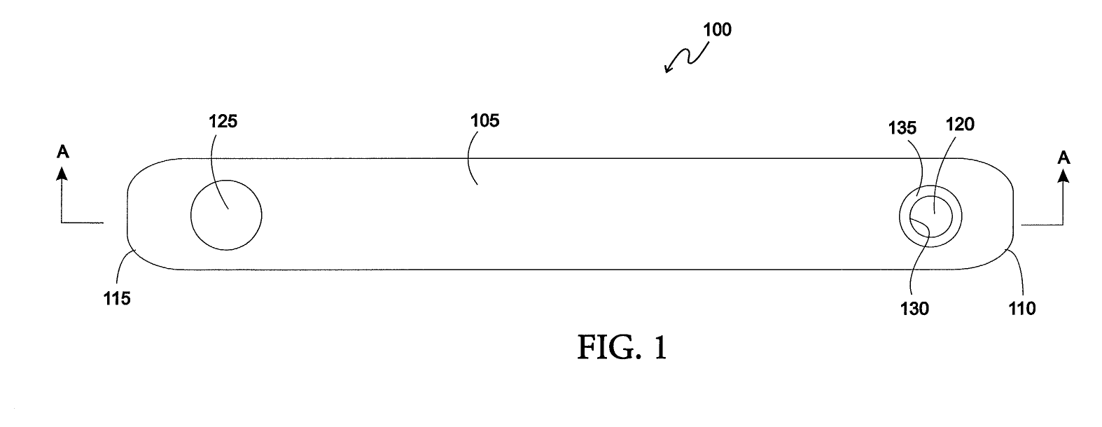

FIG. 1 is a drawing of a fastener 100 as described in various representative embodiments consistent with the teachings of the invention. In a representative embodiment, the fastener 100, whose body 105 is bendable, has a first end 110, and has a second end 115 located opposite the first end 110, comprises a first hole 120 located in proximity to the first end 110 and a second hole 125 located in proximity to the second end 115. The fastener 100 has a first surface 130 which forms a boundary of the first hole 120 with the body 105. Also, shown in FIG. 1 is a flange 135 which in this embodiment completely surrounds the first hole 120. The flange 135 could be fabricated, for example, by extrusion from the body 105 of the fastener 100, by bonding a piece of metal or other material to the body 105, or by other means.

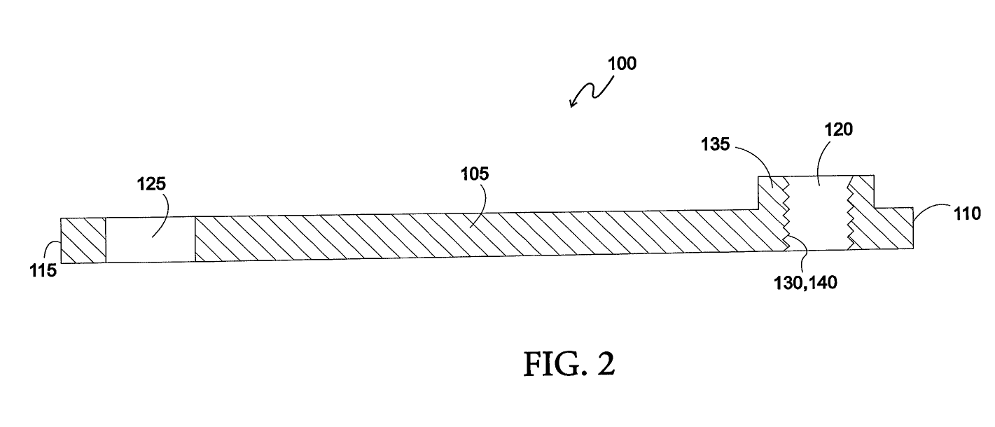

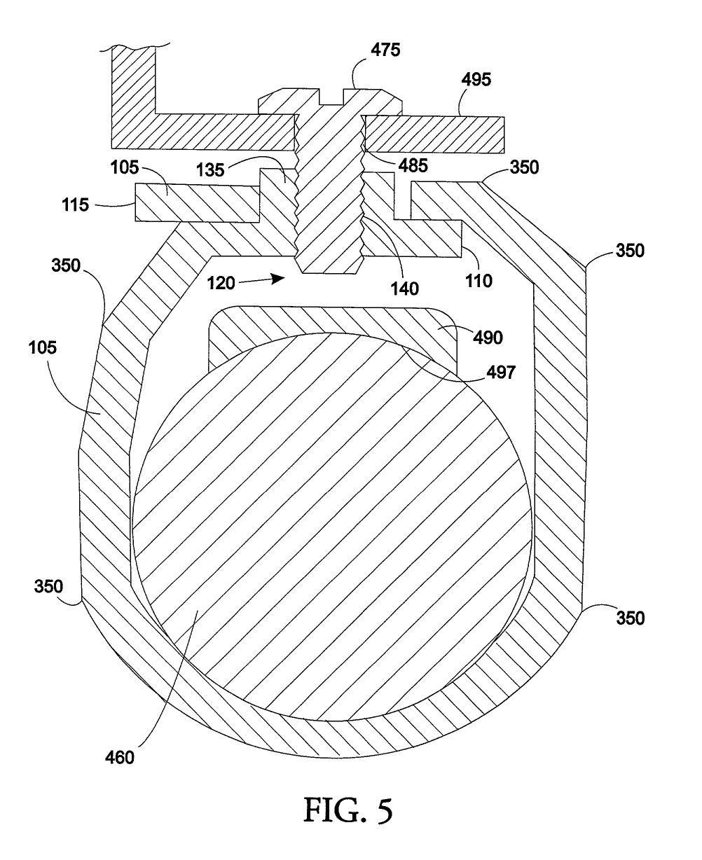

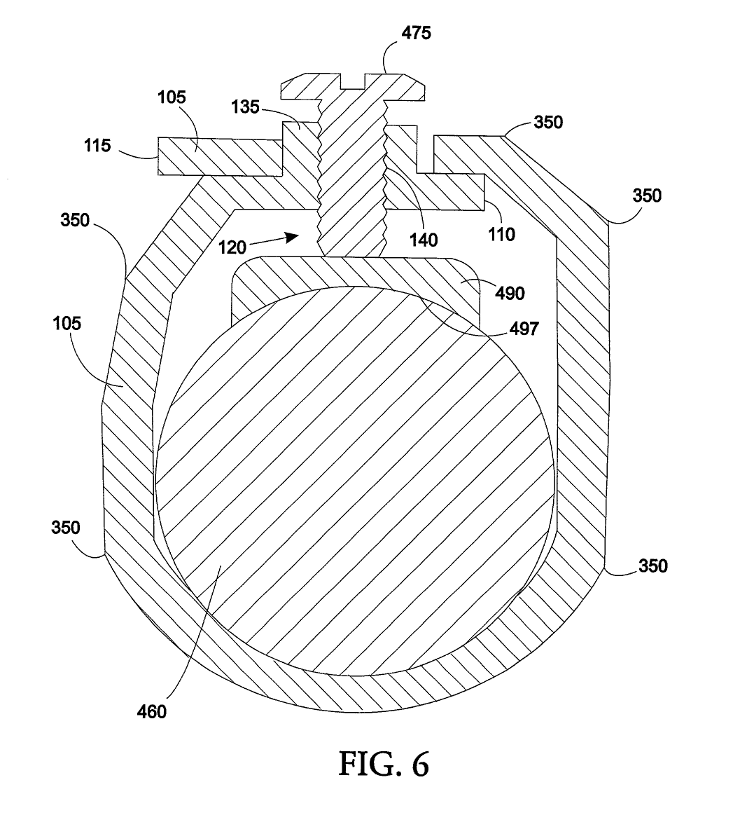

FIG. 2 is a drawing of a section of the fastener 100 on line A-A of FIG. 1 as described in various representative embodiments consistent with the teachings of the invention. Shown in cross-section in FIG. 2 are the body 105, the first and second ends 110,115, first and second holes 120,125, the first surface 130, and the flange 135. In the embodiment of FIG. 2, the first surface 130 is delineated by screw threads 140. As shown more clearly in FIGS. 5 and 6, the second hole 125 is larger than the first hole 120, and the bending of the fastener 100 permits the opening of the second hole to fully overlay the opening of the first hole 120. Flange 135 preferably ensures that the second hole 125 overlays the first hole 120 when the body 105 is bent and facilitates alignment in the attachment process. As such, in other representative embodiments, the flange 135 only partially surrounds the first hole 120, and in those embodiments forms a small protrusion on the body 105. Other representative embodiments do not include the flange 135. And in still other representative embodiments, the surface of the flange 135 closest to the first hole 120 may not align with the first surface 130 of the first hole 120. Also, the surface of the flange 135 closest to the first hole 120 may not be delineated by screw threads 140 as is shown in FIG. 2.

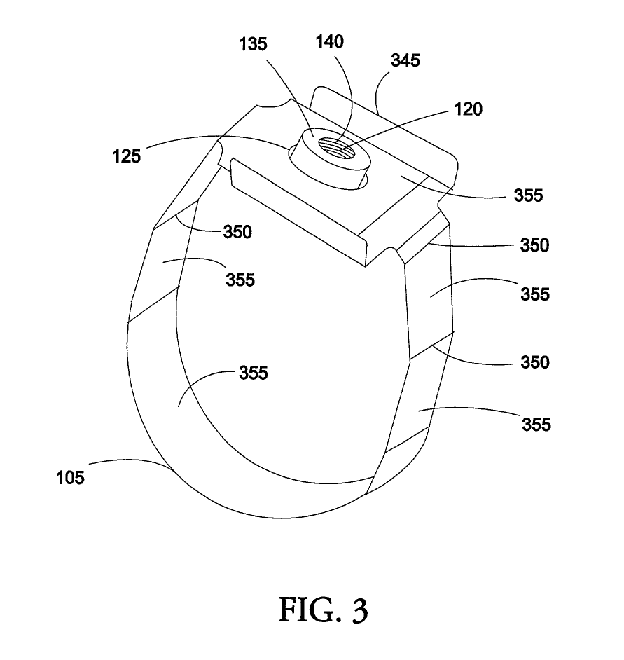

FIG. 3 is a drawing of another fastener 100 as described in various representative embodiments consistent with the teachings of the invention. The fastener 100 in FIG. 3 is shown in its bent position. The second hole 125 overlays the first hole 120 with the flange 135 inserted into the second hole 125. In this representative embodiment, the body 105 of the fastener 100 is wider in the vicinity of the first and second holes 120,125 than the remaining portions of the body 105. Other embodiments will have different areas 355 of the body 105 of different widths. The embodiment of FIG. 3 also has bent edges 345 on the sides of the first end 110 which restrict lateral movement of the second end 115 with respect to the first end 110. In addition, for some applications the body 105 may be fabricated with bends 350 located at various positions permitting stress relief in areas 355 of the body 105. The bends 350 can be designed such that areas 355 of the body 105 can more closely conform to the object around which they are attached. However, the invention is not limited to such applications.

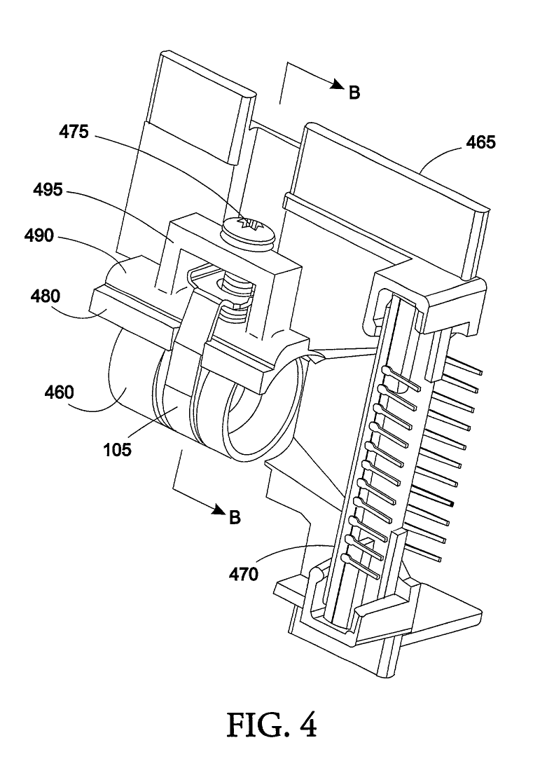

FIG. 4 is a drawing of the fastener 100 in an application as described in various representative embodiments consistent with the teachings of the invention. In FIG. 4, a lens assembly 460, also referred to herein more generally as a first object 460, is attached to an image device frame 465, also referred to herein more generally as a second object 465. The term lens assembly 460 as used herein comprises the physical lens itself in addition to any structure housing the lens. In this application, the lens assembly 460 focuses an image onto an image sensor 470 which could be for example a charge coupled device (CCD) 470. Precise alignment of the lens assembly 460 to the image sensor 470 via the image device frame 465 is important in maintaining the quality of the image focused on the image sensor 470 by the lens assembly 460. The lens assembly 460 is attached to the image device frame 465 via the fastener 100 shown in FIGS. 1, 2, and 3. The fastener further comprises a retaining screw 475, also referred to herein as a screw 475 which could be a bolt 475 or other device having screw threads with design parameters such as diameter and screw pitch approximately matching the screw threads 140 delineating the first surface 130 of the first hole 120, and a mounting bracket 480, also referred to herein as a bracket 480. The mounting bracket 480 comprises a first and second shoulders 490,495, also referred to herein as first and second protuberances 490,495. In FIG. 4, the body 105 of the fastener 100 is wrapped around the lens assembly 460, the flange 135 is inserted into the second hole 125, the screw 475 is inserted through a third hole 485 in the second shoulder 495 of the bracket 480. The bottom surface of the screw 475 shaft floats above the first shoulder 490 of the bracket 480. For clarity of illustration, the third hole 485 is not shown in FIG. 4, but is shown in FIG. 5.

FIG. 5 is a drawing, in an example application, of a section on line B-B of FIG. 4 of the fastener 100 as described in various representative embodiments consistent with the teachings of the invention. FIG. 5 is a view of a part of FIG. 4 along the axis of the lens assembly 460 in a plane perpendicular to the axis of the lens assembly 460 and passing through the centerline of the screw 475. For clarity of illustration and since their presence is not necessary for an understanding of the invention, some detail that would otherwise be seen in this view have been omitted from the figure. As stated above, the mounting bracket 480 comprises the first shoulder 490 and the second shoulder 495, both of which are mounted rigidly to the mounting bracket 480. In some applications, the mounting bracket 480 could, for cost and ease of fabrication, as well as other reasons, have additional items fabricated as integral parts of the mounting bracket 480. In FIG. 5, the screw 475 freely inserts through the third hole 485 and attaches by rotating the screw 475 to the screw threads 140 delineating the first hole 120. After exiting the lower opening of the first hole 120, the screw 475 is further tightened without pressing against the first shoulder 490 of the mounting bracket 480 but with the under side of the head of the screw 475 pressing against the second shoulder 495 until the desired level of tightness is obtained in attaching the lens assembly 460 to the image device frame 465. In the example of FIG. 5, the first shoulder 490 has a lower surface 497, also referred to herein as a first protuberance surface 497, located and formed so as to permit alignment of the lens assembly 460 with the image device frame 465. In other embodiments as a further aid in stability and alignment, the first shoulder 490 is extended outward such that it contacts the body 105 in its tightened condition.

FIG. 6 is a drawing, in another example application, of a section similar to that of line B-B of FIG. 4 of the fastener 100 as described in various representative embodiments consistent with the teachings of the invention. FIG. 6 is also a view of a part of FIG. 4 along the axis of the lens assembly 460. However, for this example the mounting bracket 480 comprises only the first shoulder 490, which is mounted rigidly to the mounting bracket 480. Again in some applications, the mounting bracket 480 could, for cost and ease of fabrication as well as other reasons, have additional items fabricated as integral parts of the mounting bracket 480. In FIG. 6, the screw 475 is attached by rotating the screw 475 in the screw threads 140 delineating the first hole 120. After exiting the lower opening of the first hole 120, the screw 475 is further tightened pressing against the first shoulder 490 of the mounting bracket 480 until the desired level of tightness is obtained in attaching the lens assembly 460 to the image device frame 465. As in the example of FIG. 5, in FIG. 6 the first shoulder 490 has a lower surface 497 located and formed so as to permit alignment of the lens assembly 460 with the image device frame 465. In other embodiments as a further aid in stability and alignment, the first shoulder 490 is extended outward such that it contacts the body 105 in its tightened condition.

A primary advantage of the invention as disclosed in various embodiments of the present patent document over prior fasteners is the fact that the fastener 100 is tightened along a line that passes through or close to the centerline of the object 460 being attached. This ensures that the fastener 100 produces lower torque on the object 460 being attached than other fasteners that do not have this feature. In applications such as the attachment of a lens assembly 460 to the frame 465 of an image device, low torque reduces the difficulty of aligning the lens assembly 460 to the associated image sensor 470.

What is claimed is:

1. A fastener for securing a first object to a second object, which comprises:
a body having a first hole and a second hole, wherein the second hole is located opposite the first hole, wherein the body is bendable, wherein the fastener has a first surface forming a boundary of the first hole, wherein the first surface is delineated by screw threads, wherein the second hole is larger than the first hole, and wherein bending the body permits the second hole to fully overlay the first hole.

2. The fastener as recited in claim 1, further comprising a screw, wherein the screw has screw threads matching those of the first hole, wherein at least a portion of the screw can be inserted through the second hole, and wherein the screw is capable of being screwed into the first hole.

3. The fastener as recited in claim 1, further comprising a bracket, wherein the bracket comprises a first protuberance wherein the first object is attachable to the first protuberance via pressure from a screw against the first protuberance.

4. The fastener as recited in claim 1, wherein a first protuberance surface is formed so as to permit alignment of the first object to the second object.

5. The fastener as recited in claim 1, further comprising a bracket, wherein the bracket comprises a first protuberance and a second protuberance wherein the first object is attachable to the first protuberance via pressure from the underside of a head of a screw against the second protuberance.

6. The fastener as recited in claim 1, wherein a flange fully surrounds the first hole.

7. The fastener as recited in claim 1, further comprising:
a flange, wherein the flange is located proximal to the first hole, wherein the flange lies external to a cylindrical projection of the first hole, wherein the projection is parallel to the centerline of the first hole, and wherein the size of the second hole permits entry of the flange into the second hole while maintaining overlay of the first hole by the second hole.

8. The fastener as recited in claim 7, wherein the flange is attached to the body.

9. The fastener as recited in claim 7, wherein a surface of the flange is further delineated by screw threads.

10. The fastener as recited in claim 9, further comprising a screw, wherein the screw has screw threads matching those of the first hole, wherein at least a portion of the screw can be inserted through the second hole, and wherein the screw is capable of being screwed into the flange and into the first hole.

11. The fastener as recited in claim 7, wherein the flange s extruded from the body of the fastener.
